(19) United States
(12) Patent Application Publication
(10) Pub. No.: US 2020/0272996 A1
(43) Pub. Date: Aug. 27, 2020

(54) REWARD BASED TALENT MANAGEMENT SYSTEM

(71) Applicant: LIRI THERAPY SERVICES LLC, Lewes, DE (US)

(72) Inventors: SAMIR RAHMAN, Sunnyvale, CA (US); RAVI CHOPRA, NEW DELHI (IN)

(73) Assignee: LIRI THERAPY SERVICES LLC, LEWES, DE (US)

(21) Appl. No.: 16/792,548

(22) Filed: Feb. 17, 2020

Related U.S. Application Data
(60) Provisional application No. 62/810,482, filed on Feb. 26, 2019.

(51) Int. Cl. G06Q 10/10; G06F 16/2457; G06Q 30/02; G06Q 30/00; G06N 5/04; G06F 16/23; G06N 20/00

(52) U.S. Cl. CPC G06Q 10/1053; G06F 16/24578; G06Q 30/0215; G06N 20/00; G06Q 30/0236; G06N 5/04; G06F 16/2379; G06Q 30/018

(57) ABSTRACT

A reward based talent management system for a specific talent to be found by a client is disclosed. The processor/server enables calculating the reward payment for the talent that were viewed or browsed or paid for the advertisement. Algorithms use specific criteria for ranking the talent and position them on the top of the list for viewing by the client. This encourages the talent to keep the resume current and be active in responding to the queries.

### CROSS REFERENCE TO RELATED APPLICATION

This application claims priority to U.S. Provisional application 62/810,482 filed on Feb. 26, 2019. The pending US Provisional application is hereby incorporated by reference in its entireties for all its teachings.

### FIELD OF TECHNOLOGY

This disclosure relates generally to an integrated system and method for reward based talent management system with a reward based incentive for a active participant.

### BACKGROUND

There are many management systems/websites/applications/portals and service providers that reward the user and not the participants. Hence there is no desire for folks to upload their resume/profile/information/data/content and keep it current. On any website/online/offline system the users just create a profile once/data is added once and is hardly updated as there is no benefit for the users/candidates/joining party to update it in form of any rewards/incentives. This deteriorates the quality of information available on the management systems/websites/application/portals and hence the need for a better system. Hence the incentive to use the management system and the frustration to find a good match is deterring both sides to be skeptical of the portal usage. In this tight talent market and in lack of skilled labor it becomes difficult for the client to find the right fit. Hence there is a need to develop an engine that is different from existing management systems.

### SUMMARY

The disclosure describes a system, a method and a process for enabling clients to find talent in an organized manner using the reward/incentive-based talent management system/search engine. In one embodiment, the talent/candidate/end user is incentivized if they are selected by the client/searching party/company. In another embodiment, the talent/candidate/profile is charged a fee to rank themselves higher compared to other talent so that the client can find them easily.

In one embodiment, a reward based talent management system residing in the processor or hardware/server/edge computing device/cloud computing is used for rewarding/incentivizing talent/candidate/profile to enroll into the system after they are discovered by the client/searching party/company. In one embodiment, the reward based talent management system and portal enables talent to upload, update and maintain their resume/information/and get exposure for a job/opening/requirement of any nature in real time. In another embodiment, a client/searching party/company is encouraged to pay per use and they are updated by the reward-based talent management system and portal instantly when their search criterion has a new or updated talent. In another embodiment, for a better ranking position the talent/candidate/profile is required to purchase an advertisement spot/better placement for visibility. The reward/incentive based talent management system/search engine uses machine learning algorithms to find talent for clients, reward/incentive talents/candidate/profile based on many specific criteria embedded in the algorithms to calculate in real time and generate view listings in real time based on talent and client input.

In one aspect, a method using a reward based talent management system and portal which includes an extensible computer process/server and providing an input guidance to available processors of an available computing environment. The method enables the talent to input professional data/information, ranked based on specific criteria, may or may not be compared to peers for ranking, evaluated based on feed back by the client (a client may comprise of any person or business that is in the market for a commodity, talent, article or services), ranked higher based on advertisement revenue, and upon discovery by the client and hiring/purchase/download the incentive will be calculated on other specific criteria and rewarded in real time. The data gathered by the talent/candidate/profile input, client/searching party/company requirement, feedback and rewards is used for machine learning algorithms to predict the best selection for clients/searching party/company for hiring, verification of talent from various sources, authentication of input provided by the talent and matching the feedback from client/searching party/company and talent on services rendered are used. The method further includes automatically recording the reward based on input and views of the talent and payment by clients in real time. The method also includes automatically assembling a response from the clients, therapist, a government authority and a licensing authority using a distributed shared output.

In another embodiment, a system, method and process enables various level of rewards when a client reviews the short form of talent page in a different form than when their resume is viewed in full. In a different embodiment, the talent is rewarded through block chain based Token, database depended calculations, cash, free upgrade for higher ranking or any other service based incentive when viewed by the client at different levels. If the full format is viewed for a few minutes they are incentivized at a different rate. The rewards are calculated based on artificial intelligence and machine learning engine for location, time of the year, demand and availability of talent, but not limited to these criteria's.

In one embodiment, the vetting process is performed using pertinent engines when talent have submitted their resume/information/data. In another embodiment, the client related reviews by the talent is a measure for future talents to accept or not accept the offer from client. In one embodiment, reward based talent management system process allows talent to sign up based on incentives for view and hire, client is provided fully screened talent with updated information and ranked candidates based on qualifier criteria's, the database for storing the data and updating in real time is performed so talent and client is current.

In one embodiment, a therapist or a medical field related professional is a talent and submits his resume with all details. A client who is seeking a therapist would preview, review, contact and hire the therapist for a fee to the host system.

The methods, systems, and processes disclosed herein may be implemented in any means for achieving various aspects, and may be executed in a form of a machine-readable medium embodying a set of instructions. Other features and embodiments will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view illustrating a reward based talent management system, according to one embodiment.

FIG. 2 is a process flow chart of the reward based talent management system, in one embodiment.

FIG. 3 is a schematic diagram of various modules of reward based talent management system and portal service, according to one embodiment.

FIG. 4 is a flow chart of the method of using the reward based talent management system and portal service, according to one embodiment.

FIG. 5 shows the method and process for running the first algorithm in the reward based talent management system.

FIG. 6 shows the method and process for running the second algorithm in the reward based talent management system.

FIG. 7 shows the method and process for running the third algorithm in the reward based talent management system.

FIG. 8 shows a therapist login page.

FIG. 9 shows therapist populating their resume.

FIG. 10 shows a client login in page.

FIG. 11 shows partial view of the therapist/talent page for client.

FIG. 12 shows full view of the talent resume page if the client is a member.

FIG. 13 shows a reward history for a particular talent.

Other features of the present embodiments will be apparent from the accompanying drawings and from the detailed description that follows.

### DETAILED DESCRIPTION

Several system, methods and processes for a reward based talent management system are disclosed. Although the present embodiments have been described with reference to specific example embodiments, it will be evident that various modifications and changes may be made to these embodiments without departing from the broader spirit and scope of the various embodiments.

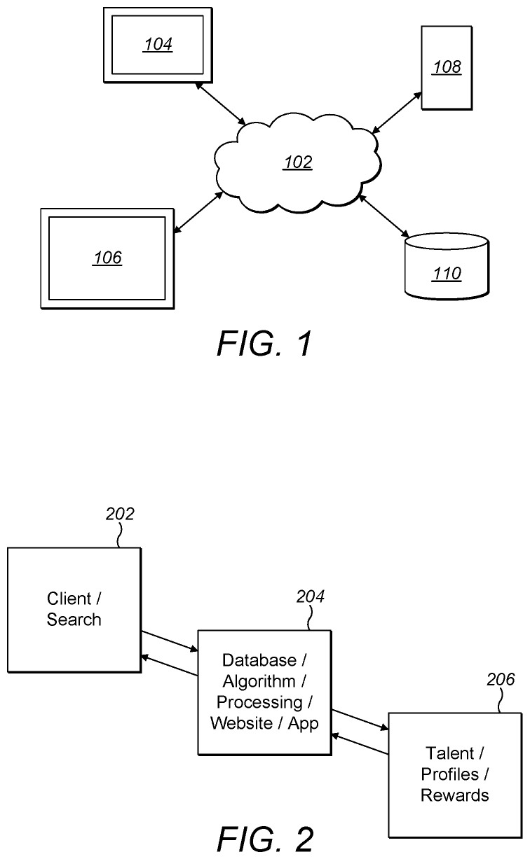

FIG. 1 is a system view illustrating system for a reward based talent management system and portal service, according to one embodiment. Particularly, FIG. 1 illustrates an internet 102, connecting devices 104,106,108 for the talent and client to use to get into the system. A database 110 to store and enable sharing of data across devices is shown. A computer device may be defined as mobile device/desk top/tablet or a virtual machine.

FIG. 2 is a process flow chart of the reward based talent management system, in one embodiment. Talent is solicited, inspired and searched to provide their profile and eventually rewarded 206 by the reward based talent management system. The data collected from inputs, various entities for verification of said input by the talent, reviews and feedback collected from client and talent, other offline sources etc., but not limited too, is stored in a database, algorithms are run to evaluate the data and the results and raw data are fed for artificial intelligence gathering and machine learning processing 204. The algorithms based on weightage ranks the talent on the web site or any device when a search is made. Client logs into the website, registers, pays for reviewing the talent of interest, reviews either briefly or in detail about a certain talent biography, shows interest in engaging in either for the services or hires the talent.

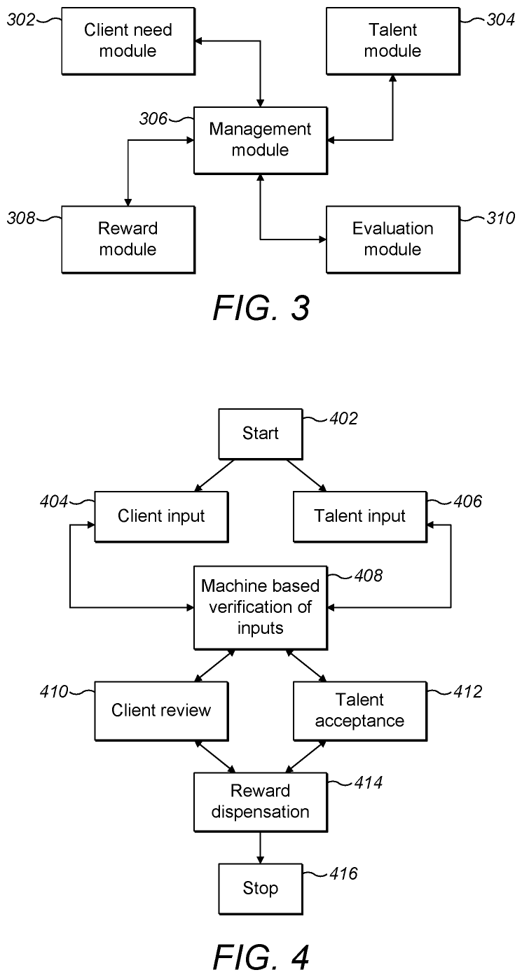

FIG. 3 shows several modules that are located on a processor or any hardware (such as the server) that can perform computation for the engine of the said system. All modules are embedded or layered or stored on server and processed via processor on a web server/local server or block chain or any hard ware that can process complex business process logic, data analytics, financial transactions, block chain calculations, machine learning algorithms and artificial intelligence algorithms for scalability and everyday use. Management module 306 is the center of the reward based talent management system and portal. This enables the client and talent input to be analyzed and distributed based on proprietary algorithms and comply with all regulatory rules. Client need module 302 receives and accepts input from clients and categorizes the data so that the algorithm calculates and helps create an input for evaluation module 310 for fees structure.

Evaluation module 310 also evaluates talent input and client input and curates the data for accuracy and pertinence. Talent module 304 which is unique for assessing and categorizing talent resume input. This is not mere text matching algorithm. It also takes into account the need that has been input by client to technically match the requirement and present the right talent to the client. Evaluation module incorporates several other criteria for ranking the talent. Talent in general terms specifies any person or entity looking to be engaged to perform a service or job for a client.

FIG. 4 shows the method and process of the reward based talent management system and portal service. Once started 402 the engines looks for client input 404 and talent input 406. The modules enable the input to be evaluated based on machine learning or processing 408. The clients review the output from the engine 410. If the talent has to be hired and the talent accepts 412 the loop of hiring is closed for example but not limited too. The novel proposition is the paid client once fulfills the payment part then the machine takes over to calculate the incentive for the talent 414. The incentive is tiered and unlimited. The more the talent gets the viewed from the portal they get more incentive. If the client is a repeat client and has hired more than a certain number then their reward may be a discount, block chain token or stars or including but not limited to or cash/gift cards. This two way feedback loop helps serve client and talent with more returns and confidence.

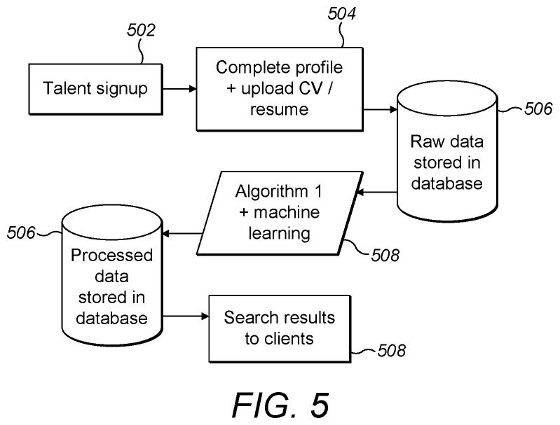

FIG. 5 shows a process and method of running the first algorithm to process talent data. A talent sign up 502, completes the profile, uploads their resume (data/information), and decides to pay or not pay for the advertisement of his profile, references; certificate and license information is collected from them 504. This raw data is stored in a database 506 for multiple purposes. The data in one embodiment is used for running the algorithm 1 and in another embodiment, used for machine learning purposes 508. The candidate signs up on the platform/site/app/portal and gives the required information either through drop down menus or blank forms. Followed by uploading their cv/profile/bio/information in any of the file formats like pdf, doc, xls, csv and with the help of machine learning we process the data and map it to the parent data of the user to bring out more relevant data that can meet the search needs/queries of the client in our search engine (talent search system/talent management system). Some of the specific criteria used and input required for algorithm 1 is as follows, but not limited to Candidate Location—city/state/pin code, age, educational qualification, skills, experience, license status, previous job experience, profile completion status, working hours availability, closeness to user need, preferred work location, preferred work hours, specialization on skills and expected salary. Processed data is stored in a secure database 506. Once the client queries results are displayed 508 to the clients.

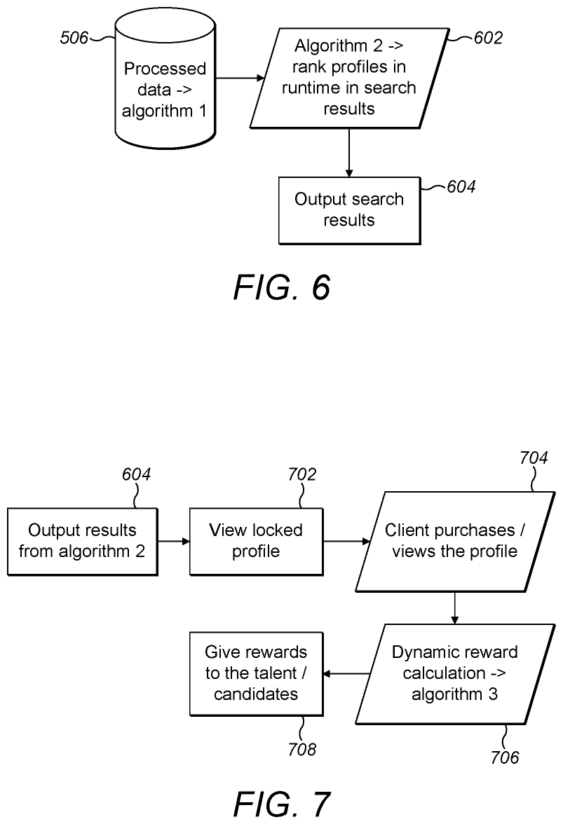

FIG. 6 from database 506 is used for running rank profile algorithm 2 in real time and search is results are produced 602. Certain steps are used for candidate search algorithm 2,

Step1: Find the total candidates with applying the filter.
Step2: Ads Candidate will be on first priority.

1. Highest rating candidate will be on top.

2. If rating is same than more number of count will be on top.

3. If rating and rating count is same then more profile progress will be more preferred.

4. If profile progress is same then most recent login will be preferred.

Step3: After Ads candidate eliminate the candidate who are not verified.

1. Highest rating candidate will be on top.

2. If rating is same than more number of count will be on top.

3. If rating and rating count is same then more profile progress will be more preferred.

4. If profile progress is same then most recent login will be preferred.

The general algorithm 2 that may be used may be, but not limited to as follows:
a. Step 1: Start
b. Step 2: Get total_candidate with applied filters
c. Step 3: find Ads_candidate and no_Ads_candidates.
d. Step 4: If Ads_candidate>0 then goto step 5 else goto step 10.
e. Step 5: find rating_of_candidates of Ads_candidate
f. Step 6: sort by rating in descending order, if rating_of_candidate is same than find count_of_rating then more count_of_rating on top.
g. Step 7: if count_of_rating is same then find profile_progress_of_candidates and go to step 8 else goto step 9.
h. Step 8: more profile_progress_of_candidate at first and accordingly last.
i. Step 9: find recent login and make preference accordingly.
j. Step 10: Eliminate no_ads_candidate who are not verified.
k. Step 11: find rating_of_candidates of no_ads_candidate
l. Step 12: sort by rating in descending order, if rating_of_candidate is same than find count_of_rating then more count_of_rating on top.
m. Step 13: if count_of_rating is same then find profile_progress_of_candidates and go to step 14 else goto step 15.
n. Step 14: more profile_progress_of_candidate at first and accordingly last.
o. Step 15: find recent login and make preference accordingly.
p. Step 16: Stop

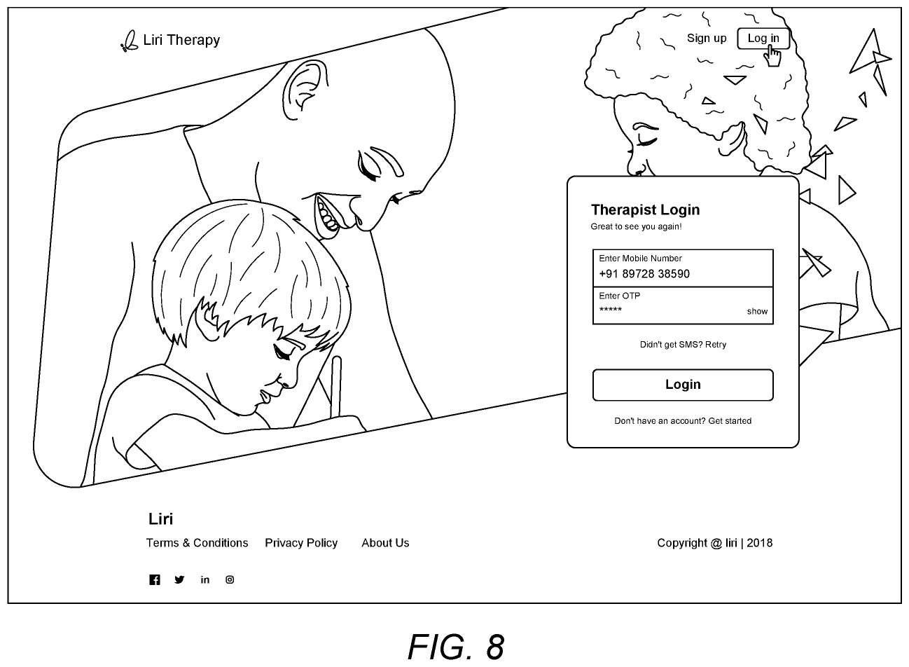

FIG. 7 shows the processing of algorithm 3 for reward generation. After step 14 of algorithm 2 the output results from algorithm 2 is locked 604. Verification is done after the view is locked 702 for accuracy using machine learning software. The locked view profile is what the clients views and decides to engage with the talent 704. Viewing, profiling, and finally engaging for services have different levels of reward generation. The feedback from clients and talents for that particular client is incorporated in algorithm 3 as artificial intelligence calculation for sentiment analysis. This score can be used for rewarding if it is better than average. Dynamic reward calculation 706 can be done in real time and rewards either in form of cash or tokens are given to talents 708. We calculate the weightage of every profile depending upon various factors as follows:
Candidate Location—city/state/pin code
Age
Educational qualification
Skills
Experience
License status
Previous Job Experience
Profile Completion Status
Working hours availability
Closeness to user need
Expected Salary
Preferred Work Location
Preferred Work Hours
Specialization on Skills

Depending upon our algorithm weightage of various factors we value the profile and based upon the same dynamic rewards are calculated and allocated to the candidates if their profile is viewed/purchased by the clients.

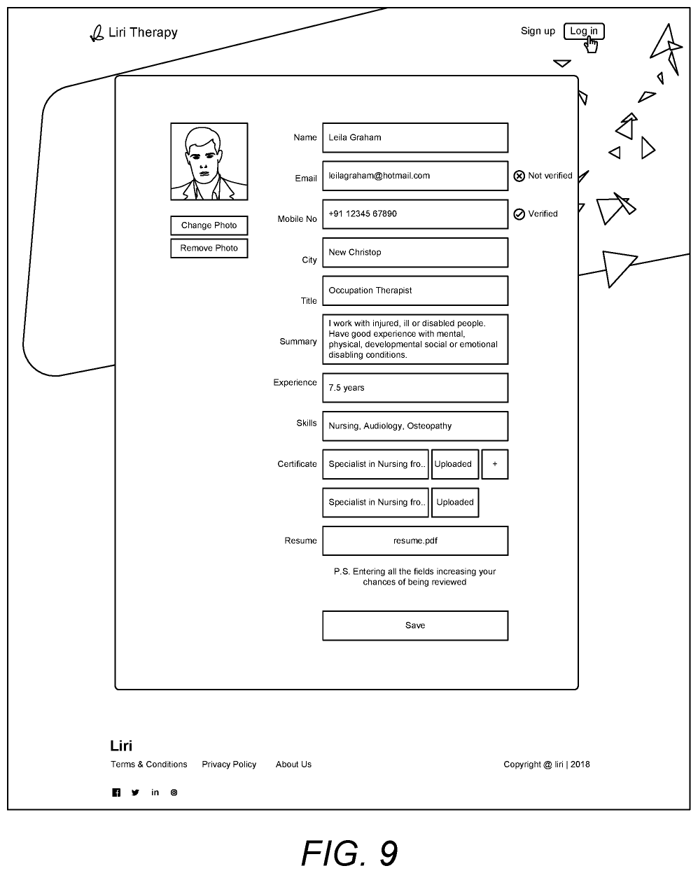

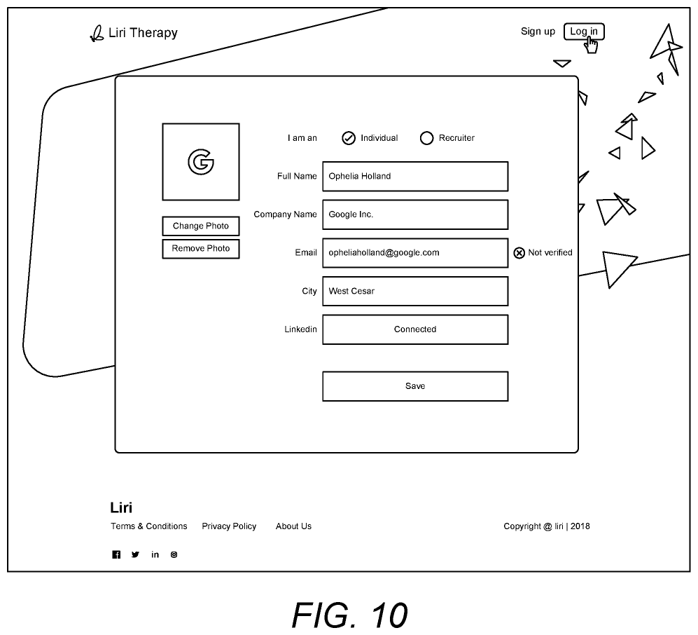

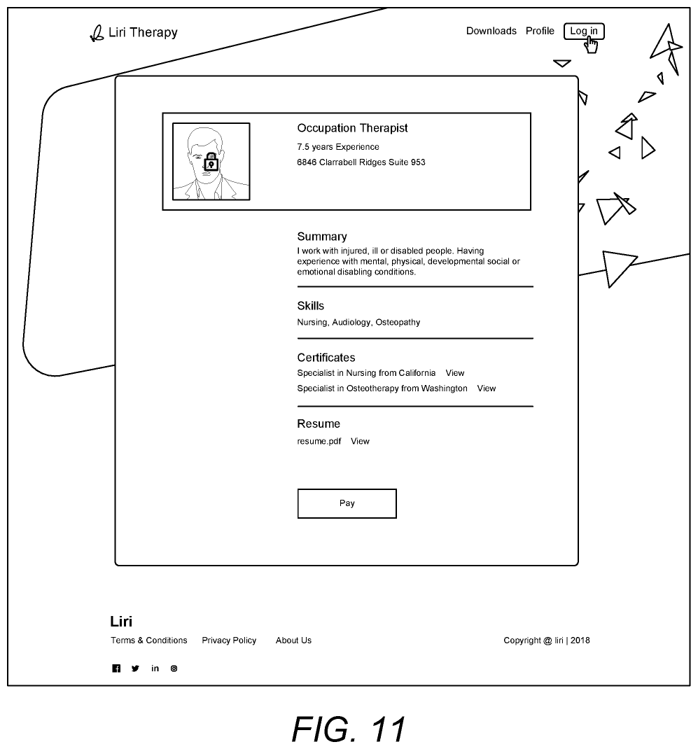

FIG. 8 shows a therapist login. Verification of several terms are done before they are allowed to be a member of this system and portal. Qualified, background checked and licensed therapists are encouraged to become members and fulfill their full resume (FIG. 9). FIG. 10 shows that companies or individuals can become clients and input their profile and requirements. The artificial engine module may be designed to paraphrase their requirement by gentle suggestions so they find the right match.

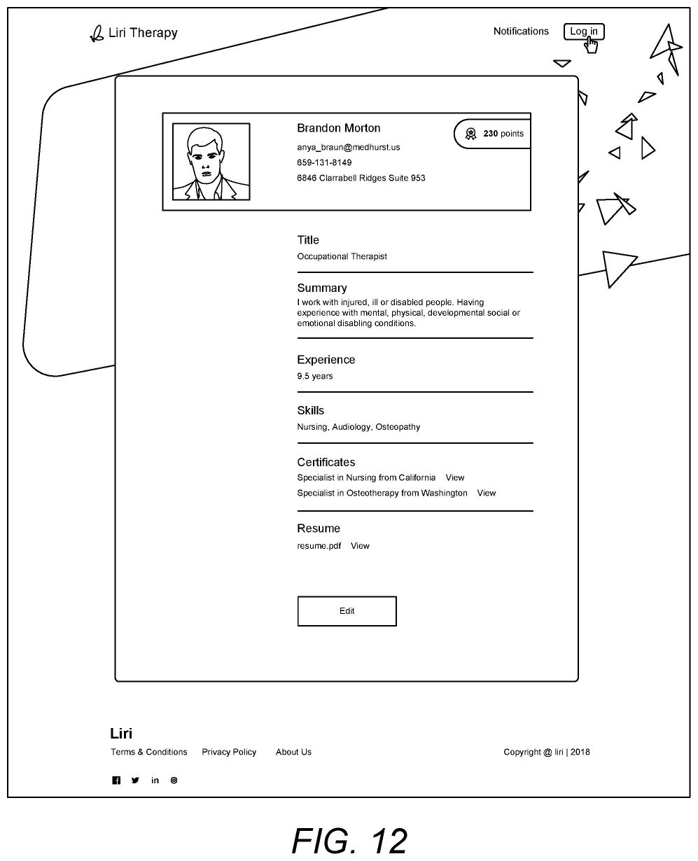

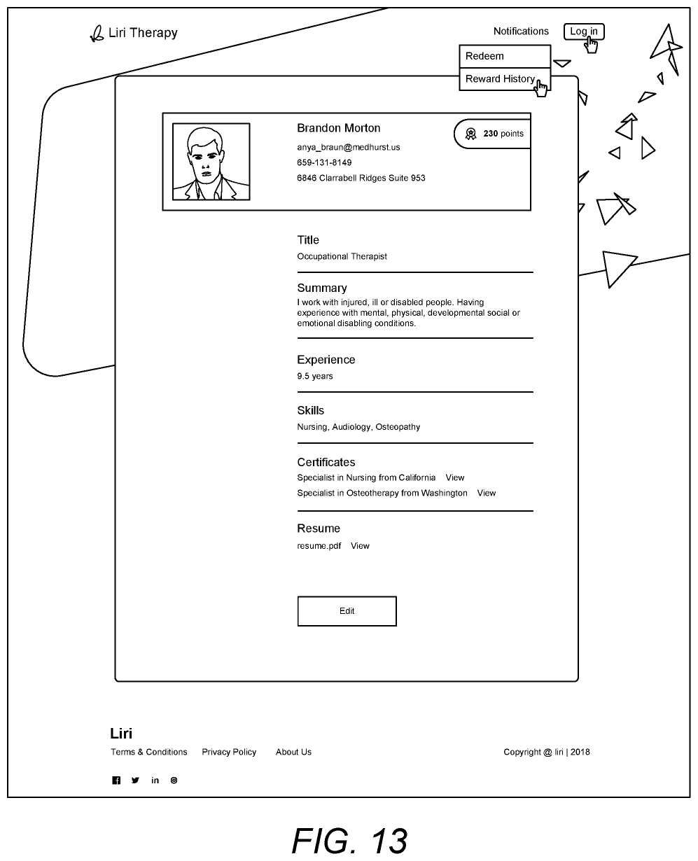

FIG. 11 enables the client to preview the therapist in a brief way before they are allowed to view the entire profile. This enables the management module to calculate incentive based on preview and full review. Clients may or may not be members for viewing brief description. Only paid clients are allowed to view full talent profile (FIG. 12). The individuals/therapists can track how many times they have been hired by looking at their review and reward history (FIG. 13).

What is claimed is:

1. A reward based talent management system, comprising:
a server hosting and processing the following modules for the reward based talent management system:
a. a talent module capturing an input data from a talent using a computer device;
b. a client module enabling search for a client to search and procure the talent;
c. a talent ranking module to rank the talent based on a specific criteria for the client;
d. an evaluation module to capture the client feedback and the talent feedback regarding the client to be stored in a database so that a management module calculates the efficiency and type of service rendered by the talent and client;
e. a reward module to calculate and provide a specific incentive to the talent based over a period of time; and
a database to store input from all the modules and provide data for a management module housing an algorithm to rank the talent.

2. The system of claim 1, wherein the processor is located in a mobile device, cloud based processing center, and a network supporting hardware.

3. The system of claim 1, wherein the specific incentive is at least one of a revenue share or points.

4. The system of claim 1, wherein the input data are a talent location, age, educational qualification, skills, experience, license status, previous relevant job experience, profile completion status, working hours availability, closeness to client location and need, expected salary, preferred work location, preferred work hours, specialization on skills, social media page evaluation and reward status.

5. The system of claim 1, wherein the algorithm ranks the talent based on the specific criteria.

6. The system of claim 1, wherein the algorithm calculates the incentive.

7. A reward based talent management system, comprising:
A computer device to receive an input data from a talent and a client to select a well ranked talent and storing the input data in a database;
A server to calculate a ranking of the talent based on the input data received from the database and calculating in real time using an algorithm 1 and algorithm 2; and
A computer device to display for the client a best ranked talent based on the client requirement.

8. The system of claim 7, wherein the input data for the talent selection is algorithm 1 depends on are a talent location, age, educational qualification, skills, experience, license status, previous relevant job experience, profile completion status, working hours availability, closeness to client location and need, expected salary, preferred work location, preferred work hours, specialization on skills, social media page evaluation and reward status.

9. The system of claim 8, wherein algorithm 2 depends on an ad paid talent or non-ad paid talent to display the best ranked talent for the client.

10. The system of claim 7, further comprising;
An evaluation module to calculate and provide an incentive to the talent based on number of views, ranking of talent, client engagement, demand and reviews.
